(19) United States
(12) Patent Application Publication
(10) Pub. No.: US 2012/0297355 A1
(43) Pub. Date: Nov. 22, 2012

(54) WHITESPACE CREATION AND PRESERVATION IN CIRCUIT DESIGN

(75) Inventors: Charles Jay Alpert, Austin, TX (US); Gi-Joon Nam, Austin, TX (US); Shyam Ramji, Lagrangeville, NY (US); Jarrod Alexander Roy, Austin, TX (US); Paul G. Villarrubia, Austin, TX (US); Natarajan Viswanathan, Austin, TX (US)

(73) Assignee: International Business Machines Corporation, Armonk, NY (US)

(21) Appl. No.: 13/112,098

(22) Filed: May 20, 2011

(51) Int. Cl. G06F 17/50

(52) U.S. Cl. 716/135

(57) ABSTRACT

A method, system, and computer program product for whitespace creation and preservation in the design of an integrated circuit (IC) are provided in the illustrative embodiments. A first estimate is formed by estimating an amount of whitespace that is needed to reduce a congestion value of a congested area of the design to a threshold value. A set of virtual filler cells is added to the congested area, wherein adding the set of virtual filler cells does not add actual whitespace cells to the congested area but reduces the congested area by at least the first estimate. A virtual filler cell in the set of virtual filler cells is replaced with a corresponding real filler cell. A determination is made whether the design has improved. A final placement solution is created when the design has not improved.

### BACKGROUND

1. Technical Field

The present invention relates generally to a method, system, and computer program product for designing an integrated circuit. More particularly, the present invention relates to a method, system, and computer program product for creating and preserving whitespaces during cell placement in the integrated circuit (IC) design process.

2. Description of the Related Art

Modern day electronics include components that use integrated circuits. Integrated circuits are electronic circuits formed using Silicon as a substrate and by adding impurities to form solid-state electronic devices, such as transistors, diodes, and resistors. Commonly known as a “chip”, an integrated circuit is generally encased in hard plastic, forming a “package”. The components in modern day electronics generally appear to be rectangular black plastic pellets with connector pins protruding from the plastic encasement. Often, many such packages are electrically coupled so that the chips therein form an electronic circuit to perform certain functions.

The software tools used for designing ICs (design tools) produce, manipulate, or otherwise work with the circuit layout and circuit components on very small scales. Some of the components that such a tool may manipulate may only measure a few nanometers across when formed in Silicon.

The designs produced and manipulated using these software tools are complex, often including millions of such components interconnected to form an intended electronic circuitry. An interconnected group of components is called a net.

The design tools manipulate these components at the components level, or blocks of components level. A block of components is also known as a cell. A cell in an IC design is a portion of the IC design, or an object that has to be placed by the design tool.

An imaginary grid of horizontal and vertical lines on the chip's design creates bins. A cell can be contained in one bin or can span multiple bins. A local area of a design is an area occupied by one bin or more than one bins depending on the implementation.

A design tool can, among other functions, manipulate cells, or interconnect components of one cell with components of other cells, such as to form nets. The interconnects between components are called wires. A wire is a connection between parts of electronic components, and is formed using a metallic material that conducts electricity.

Placement problem is the problem of placing the cells of a chip such that the design meets all the design parameters of the chip. Routing is the process of connecting the pins after placement. In other words, placement results in a rendering of the components of various cells as being located in certain positions in the design, whereas routing results in a rendering of how the metal layers would be populated with that placement.

A wire can be designed to take any one of the several available paths in a design. Placement of a wire on a certain path, or track, is a part of routing.

A router is a component of a design tool that performs the routing function. Once the placement component—known as a placer—has performed the placement function, the router attempts to connect the wires without causing congestion. For example, if a design parameter calls for no more than five wires in a given area, the router attempts to honor that restriction in configuring the wiring. Such limitations on the wiring are a type of design constraints and are called congestion constraints. Other types of design constraints may include, for example, blocked areas—areas where wires may not be routed.

A global router divides the routing region into small tiles called global routing cells, or g-cells, and attempts to route nets through the tiles such that no tile overflows its capacity. After global routing, wires must be assigned to actual tracks within each g-cell, followed by detail routing, which must connect each global route to the actual pin shape on the g-cell.

Another type of router—known as the detailed router—performs the detailed routing. The global and detailed routing produced during the design process is collectively referred to as “routing” and is usually further modified during optimization of the design. The placement, optimization, and routing steps are repeated, often through many iterations, for progressively improving the design of the IC.

### SUMMARY

The illustrative embodiments provide a method, system, and computer program product for whitespace creation and preservation in circuit design. An embodiment estimates, forming a first estimate, an amount of whitespace that is needed to reduce a congestion value of a congested area of the design to a threshold value. The embodiment adds a set of virtual filler cells to the congested area. The adding of the set of virtual filler cells does not add actual whitespace cells to the congested area but reduces the congested area by at least the first estimate. The embodiment replaces a virtual filler cell in the set of virtual filler cells with a corresponding real filler cell. The embodiment determines whether the design has improved. The embodiment creates a final placement solution when the design has not improved.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a method of creating whitespace in an IC design using virtual filler cells in accordance with an illustrative embodiment;

FIG. 4 depicts a block diagram of a method of preserving whitespace in an IC design using real filler cells in accordance with an illustrative embodiment;

FIG. 5 depicts a block diagram of another method of preserving whitespace in an IC design using real filler cells in accordance with an illustrative embodiment; and

FIG. 6 depicts a flowchart of an example process of creating and preserving whitespaces in an IC design in accordance with an illustrative embodiment.

### DETAILED DESCRIPTION

Placement solutions for an IC design often result in congestion during routing. Iteratively changing the placement solution to achieve reduced congestion during routing is one technique used to address this routing problem.

One presently used technique for avoiding routing congestion is to artificially inflate or expand the size of certain components, or a group of components, or a cell (collectively referred to as “an object”) occupying a congested g-cell so that the inflated object will no longer fit within the congested g-cell. The invention recognizes that inflating an object deteriorates the spreading performance. Spreading and legalization is a step performed after the placement step to ensure that objects do not overlap each other. Larger inflated objects are more difficult to spread than the original objects, and their spreading causes fragmentation in the IC design.

Another presently used technique for avoiding routing congestion is to modulate a local area. Modulating a local area causes a fixed limit to be imposed on how many cells can be accommodated in that local area. The invention recognizes that such a solution is wasteful of the space resources available in the local area. The invention further recognizes that modulating a local area is also an inflexible solution because placement can and does change from iteration to iteration, causing the density in the local area to change with iterations. Fixed modulation of the local area, therefore, may be suitable for one iteration but not the next.

A whitespace is an area designated in a bin where no logic can be placed. In other words, whitespace is an empty region within the placement image where no objects can be placed. Wires can pass through these empty regions if required. Although not occupied by any objects in actuality, whitespace is treated as a space/area that is already occupied.

In one presently available technique, whitespace is inserted in a congested g-cell to move some objects out of the bin. The invention recognizes that the presently available method of inserting whitespaces works only within a single iteration and that whitespace is consumed, used-up, or occupied by objects in subsequent iterations. Introducing whitespace to reduce congestion in one iteration and then consuming the whitespace in another iteration complicates the design process and nullifies some of the design progress made in the previous iterations.

The illustrative embodiments used to describe the invention generally address and solve the above-described problems and other problems related to IC design process. The illustrative embodiments provide a method, system, and computer program product for improved whitespace creation and preservation in IC design.

The illustrative embodiments are described with respect to certain ICs or circuits only as examples. Such descriptions are not intended to be limiting on the invention. For example, an illustrative embodiment described with respect to a microprocessor design can be implemented with respect to any other IC design that can be improved using whitespaces creation and preservation process of an embodiment.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

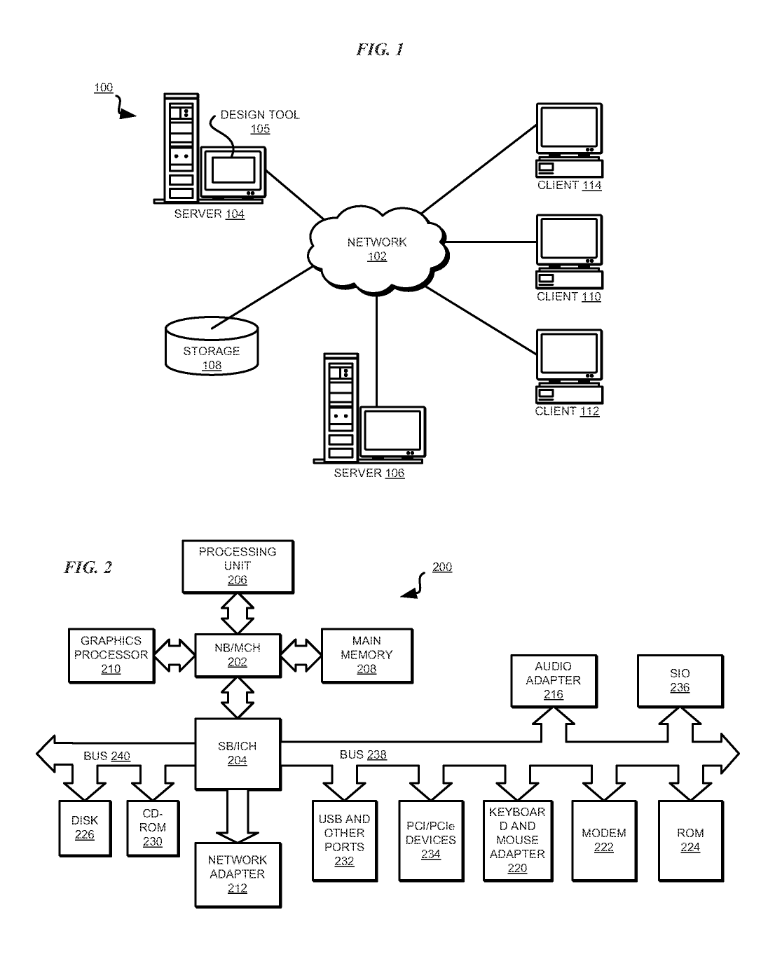

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Any data processing system, such as server 104, may include design tool 105 that may be improved using an embodiment. For example, an application using any combination of hardware and software may implement an embodiment of the invention such that the application is usable with router 105 for whitespace creation and preservation in IC design.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

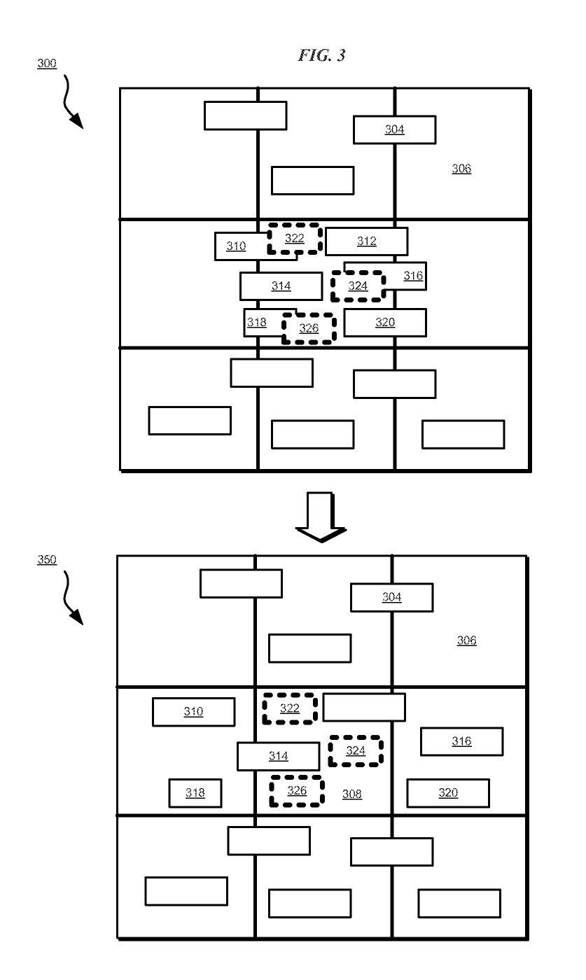

With reference to FIG. 3, this figure depicts a block diagram of a method of creating whitespace in an IC design using virtual filler cells in accordance with an illustrative embodiment. Design 300 may be a design that may be created using design tool 105 in FIG. 1.

Cell 304 is an example representation of a cell in design 300 and any number of similar cells may be present in design 300. Bin 306 is an example bin in design 300 and any number of similar bins may be present in design 300.

Consider bin 308, which is occupied by cells 310, 312, 314, 316, 318, and 320. Assume that occupation by cells 310-320 causes routing congestion in bin 308.

A virtual filler cell is a type of whitespace that does not actually occupy any space but operates to decrease a bin's capacity (by taking away the space equivalent to the area of the whitespace). In other words, if a bin were x square nanometers in size, and each of virtual filler cells 322, 324, and 326 were a, b, and c square nanometers in size respectively, the placement solution will treat bin 308 as if bin 308 were of size (x-a-b-c) square nanometers.

A whitespace cell is an actual cell that includes only whitespace. Note that while a whitespace cell is an actual cell with limitations on what can (not) go into that cell, a virtual filler cell is only a mathematical construct that adjusts the area resource available in a bin. In other words, a virtual filler cell acts like a whitespace cell without being an actual whitespace cell in a given bin. Accordingly, the visual depiction of virtual filler cells 322, 324, and 326 is only for the clarity of the description and is not intended to be interpreted as actual cells occupying space in bin 308.

Design 350 is a version of design 300 after the spreading and legalization step has been performed on design 300. Once virtual filler cells 322-326 are added to bin 308 of design 300, to wit, bin 308's available area correspondingly reduced, the spreading and legalizing step spreads cells 310, 316, 318, and 320 to outside bin 308 to avoid overlap with virtual filler cells 322, 324, and 326. Note that because virtual filler cells 322-326 are not actually cells occupying bin 308, the spreading and legalization step cannot actually move the virtual filler cells 322-326 out of bin 308 instead of cells 310, 316, 318, and 320. Therefore, upon spreading and legalization, cells 310, 316, 318, and 320 occupy their new positions as depicted in design 350.

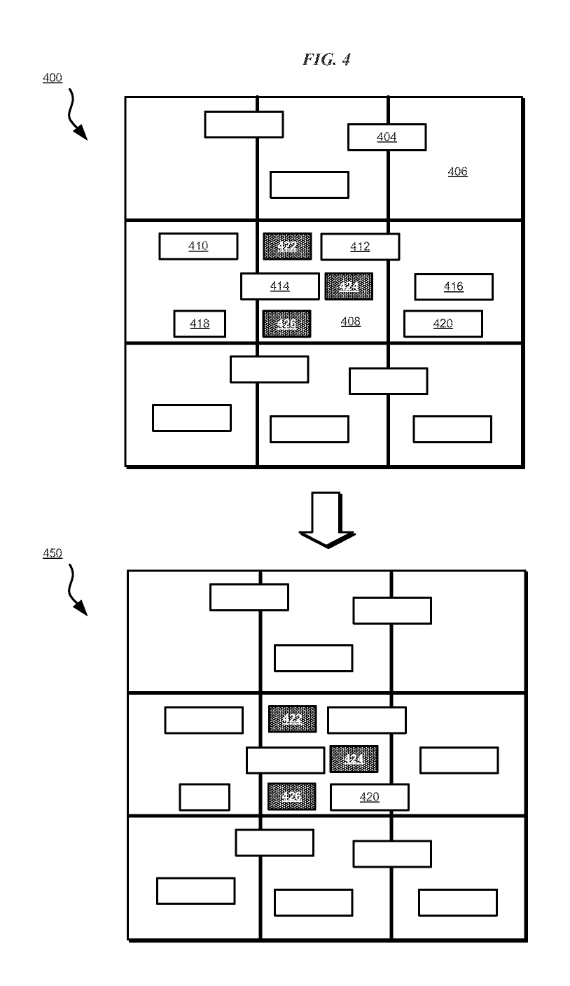

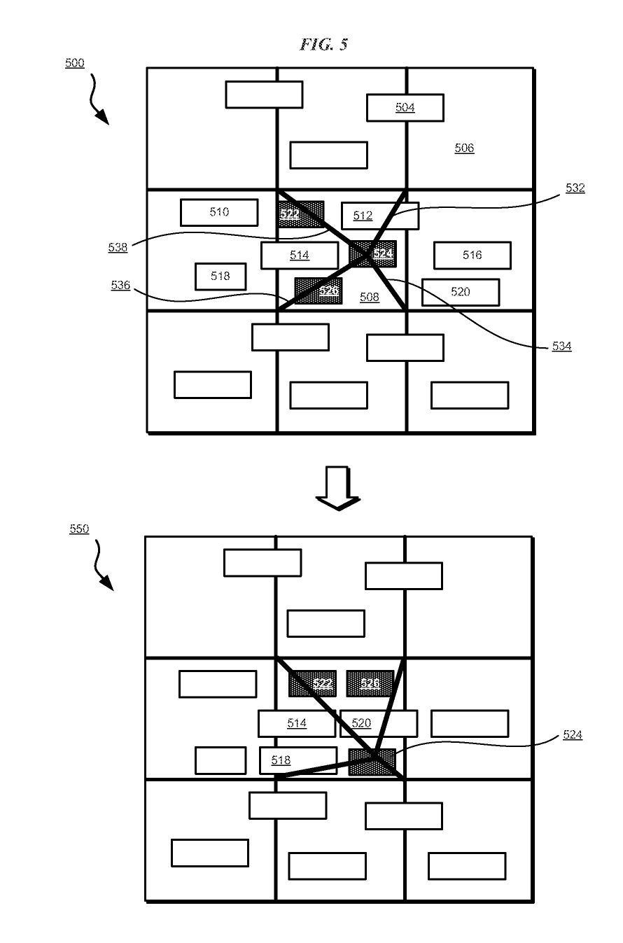

With reference to FIG. 4, this figure depicts a block diagram of a method of preserving whitespace in an IC design using real filler cells in accordance with an illustrative embodiment. Design 400 may be analogous to design 350 in FIG. 3. Artifacts 304-320 in design 350 in FIG. 3 correspond to artifacts 404-420 respectively in design 400.

Upon legalization, when bin 308 in design 350 in FIG. 3 is no longer over-subscribed or over-utilized, virtual filler cells 322, 324, and 326 in design 350 in FIG. 3 should be replaced with real filler cells analogous to actual whitespace cells to avoid repacking bin 308 in design 350 in FIG. 3. Accordingly, virtual filler cells 322, 324, and 326 in design 350 in FIG. 3 are replaced with real filler cells 422, 424, and 426 in design 400.

As a result of this replacement, as depicted in design 450, bin 408 can be repopulated differently from bin 408 in design 400 during a subsequent iteration without losing the whitespace effectively created by virtual filler cells in a previous iteration. Design 450 shows that cell 420 has been moved into bin 408 again but the congestion avoidance created by virtual filler cells 322, 324, and 326 in design 350 in FIG. 3 is maintained by real filler cells 422, 424, and 426.

Furthermore, a real filler cell, such as any of real filler cells 422, 424, or 426 in design 450 can be fixed at a specified location in bin 408. In other words, a real filler cell can be designated as immovable for subsequent iterations of placement, spreading, and legalization steps. Designating a real filler cell as immovable from a designated bin causes the whitespace effect of the virtual and real filler cells to be maintained for that bin, and causes only other movable cells to be moved in or out of the designated bin as may be needed in a particular iteration.

With reference to FIG. 5, this figure depicts a block diagram of another method of preserving whitespace in an IC design using real filler cells in accordance with an illustrative embodiment. Design 500 may be analogous to design 400 in FIG. 4. Artifacts 404-420 in design 400 in FIG. 4 correspond to artifacts 504-520 respectively in design 500.

Real filler cells 522, 524, and 526 correspond to real filler cells 422, 424, and 426 respectively in design 400 FIG. 4, except that one or more of real filler cells 522-526 may be made movable within bin 508. As an example, real filler cell 524 is depicted and described as being movable within bin 508.

In accordance with an embodiment, a real filler cell should remain within the bin where a corresponding virtual filler cell was created. A real filler cell can be made movable within a bin by associating with the real filler cell certain nets whose total wirelength cannot exceed a given length. In other words, the real filler cell is movable so long as the total wirelength of the nets remains the same or less than a specified or predetermined length.

As an example, in design 500, real filler cell 524 has four nets 532, 534, 536, and 538 connecting real filler cell 524 to two or more anchor points within bin 508. As an example, the anchor points are selected to be the four corners of bin 508, but an anchor point may be located anywhere inside or outside bin 508 without limitation. A sum of wirelengths of nets 532, 534, 536, and 538 can be determined and set as the threshold restriction on the total wirelength of nets associated with real filler cell 524.

Now, when real filler cell 524 is moved within bin 508, the total wirelengths of nets 532, 534, 536, and 538 will remain the same even though the wirelength of any one or more of nets 532, 534, 536, and 538 may change. If an attempt to move real filler cell 524 out of bin 508 is made, the total wirelength of nets 532, 534, 536, and 538 will exceed the threshold total wirelength, thereby violating the threshold total wirelength restriction, and restricting the movement of real filler cell 524 out of bin 508.

Design 550 depicts an example movement of real filler cell 524 within bin 508, and accommodation of another cell, 518, in bin 508 as a result. Other real filler cells can be restricted using this technique or another technique to accomplish a similar purpose within the scope of the invention.

Note that a real filler cell is different from a whitespace cell at least in that a real filler cell replaces a corresponding virtual filler cell, whereas a whitespace cell has no such corresponding virtual construct. Note also that allowing nets to be connected to real filler cells, such as for restricting movement to within a designated bin, further differentiates the real filler cells from the whitespace cells of the prior art, which cannot be occupied by logic or wire.

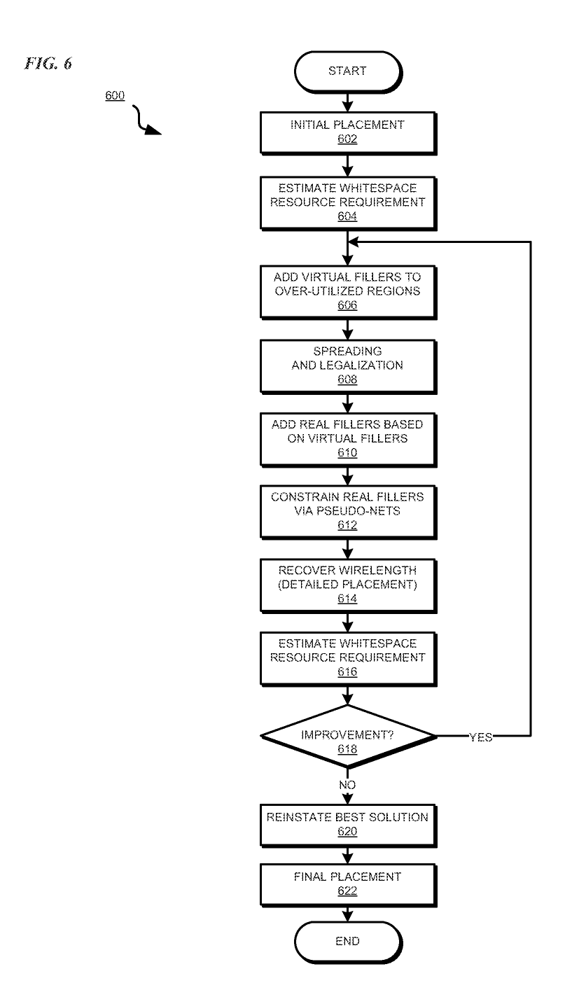

With reference to FIG. 6, this figure depicts a flowchart of an example process of creating and preserving whitespaces in an IC design in accordance with an illustrative embodiment. Process 600 may be implemented in a design tool, such as design tool 105 in FIG. 1.

Process 600 begins by determining an initial placement solution for a design (step 602). Process 600 estimates a whitespace resource requirement for certain areas, local areas, or bins of congestion (collectively referred to as “congested area”) in the design (step 604). In other words, in step 604, process 600 determines how much whitespace has to be created in an area of congestion to make the congestion metric for that area fall within a prescribed limit.

Process 600 creates and adds to the congested area, a set of virtual filler cells whose total area is at least equal to the estimate of step 604 (step 606). A set of virtual filler cells is one or more virtual filler cells. Process 600 performs the spreading and legalization of the design including the virtual filler cells (step 608).

Once process 600 has estimated the whitespace resource requirement, the white space resource requirement is translated it into an area requirement corresponding to the virtual fillers. Process 600 adds real filler cells based on the virtual filler cells (step 610). Optionally, process 600 may constrain real filler cells to the congested area by using a set of pseudo-nets, such as nets 532, 534, 536, and 538 in FIG. 5 (step 612). A set of pseudo-nets is two or more pseudo nets.

Process 600 may perform detailed placement to recover the wirelength of the design (step 614). For example, the factoring in of the virtual filler cells and the insertions of corresponding real filler cells may deteriorate the wirelengths of certain cells in the design. Step 614 may be used to adjust the placement of cells to recover from such wirelength deterioration.

Process 600 re-estimates whitespace resource requirement (step 616). Comparing the whitespace resource requirement of step 616 with that of step 604, process 600 determines whether the congestion situation in the design has improved (step 618). For example, if whitespace required in step 616 is less than the whitespace estimated in step 604 by at least a threshold amount, process 600 may determine in step 618 that the design has improved.

If the design has improved (“Yes' Path of step 618), process 600 returns to step 606 and recomputes the virtual filler cells' size, number, position, or a combination thereof, according to the estimate of step 616. If the design has not improved, i.e., the estimate of step 616 is not smaller than the estimate of step 604 by at least the threshold amount (”No” path of step 618), process 600 determines that the previous iteration had the best placement solution (having least congestion) among the executed iteration and reinstates that solution (step 620). Process 600 creates a final placement based on that reinstated solution with the least congestion (step 622). Process 600 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for whitespace creation and preservation in an IC design process. Using an embodiment of the invention in an example implementation, better congestion solution was obtained as compared to an inflation based scheme used on the same design.

An embodiment can be configured to enable varying the size and amount of filler cells based on the design objectives. An advantage of an embodiment may be that the optimization process cannot repack a bin that has been de-congested using the virtual and real filler cells. Because an actual cell or object in the design is not inflated, the spreading step does not result in fragmentation of the design to the same extent that an inflation based solution would fragment. Furthermore, an embodiment allows targeted, region-based congestion solution, allowing a design tool to address only those areas of congestion that exceed a specific congestion criterion.

An embodiment can be used during global routing for global routing congestion mitigation. An embodiment can also be used during local routing for local routing improvements, such as for improving pin-access. An embodiment can be used for adding, modifying, or otherwise manipulating space in a design, such as for timing optimization transforms. Some examples of timing optimization transforms that can benefit from an embodiment are buffer insertion and gate sizing.

An embodiment can be used generally for technology-specific applications and engineering change order (ECO) processing. During the later stages of physical synthesis, an embodiment may be used to add special cells like nwell fillers or decap fillers for which an embodiment may enable reserving space in advance.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for whitespace creation and preservation in a design of an integrated circuit (IC), the method comprising:
estimating, forming a first estimate, an amount of whitespace that is needed to reduce a congestion value of a congested area of the design to a threshold value;
adding a set of virtual filler cells to the congested area, wherein the adding the set of virtual filler cells does not add actual whitespace cells to the congested area but reduces the congested area by at least the first estimate;
replacing a virtual filler cell in the set of virtual filler cells with a corresponding real filler cell;
determining whether the design has improved; and
creating a final placement solution when the design has not improved.

2. The computer implemented method of claim 1, wherein the determining whether the design has improved further comprises:
estimating, forming a second estimate, a second amount of whitespace that is needed to reduce the congestion value of the congested area of the design to the threshold value;
determining whether the second estimate is smaller than the first estimate by a threshold difference; and
concluding that the design has improved responsive to the second estimate being smaller than the first estimate by at least the threshold difference.

3. The computer implemented method of claim 2, wherein when the second estimate is not smaller than the first estimate by at least the threshold difference, further comprising:
reinstating a previous placement solution; and
creating the final placement solution from the reinstated previous placement solution.

4. The computer implemented method of claim 1, wherein the real filler cell is immovable from a designated location in the congested area.

5. The computer implemented method of claim 1, wherein the real filler cell is movable only within a designated area in the congested area.

6. The computer implemented method of claim 5, wherein the real filler cell is constrained from moving out of the designated area by a set of pseudo-nets.

7. The computer implemented method of claim 1, further comprising:
performing a spreading and legalization operation on the design including the set of virtual filler cells.

8. The computer implemented method of claim 1, further comprising:
determining an initial placement solution, wherein the first estimate is based on the initial placement solution.

9. The computer implemented method of claim 1, further comprising:
converting the set of virtual filler cells into an area requirement, wherein the real filler cell is a real filler cell in a set of real filler cells, and wherein the set of real filler cells is created to have an area corresponding to the area requirement.

10. The computer implemented method of claim 1, wherein the congested area is a bin.

11. A computer usable program product comprising a computer usable storage medium including computer usable code for whitespace creation and preservation in a design of an integrated circuit (IC), the computer usable code comprising:
computer usable code for estimating, forming a first estimate, an amount of whitespace that is needed to reduce a congestion value of a congested area of the design to a threshold value;
computer usable code for adding a set of virtual filler cells to the congested area, wherein the adding the set of virtual filler cells does not add actual whitespace cells to the congested area but reduces the congested area by at least the first estimate;
computer usable code for replacing a virtual filler cell in the set of virtual filler cells with a corresponding real filler cell;
computer usable code for determining whether the design has improved; and
computer usable code for creating a final placement solution when the design has not improved.

12. The computer usable program product of claim 11, wherein the determining whether the design has improved further comprises:
computer usable code for estimating, forming a second estimate, a second amount of whitespace that is needed to reduce the congestion value of the congested area of the design to the threshold value;
computer usable code for determining whether the second estimate is smaller than the first estimate by a threshold difference; and
computer usable code for concluding that the design has improved responsive to the second estimate being smaller than the first estimate by at least the threshold difference.

13. The computer usable program product of claim 12, wherein when the second estimate is not smaller than the first estimate by at least the threshold difference, further comprising:
computer usable code for reinstating a previous placement solution; and
computer usable code for creating the final placement solution from the reinstated previous placement solution.

14. The computer usable program product of claim 11, wherein the real filler cell is immovable from a designated location in the congested area.

15. The computer usable program product of claim 11, wherein the real filler cell is movable only within a designated area in the congested area.

16. The computer usable program product of claim 15, wherein the real filler cell is constrained from moving out of the designated area by a set of pseudo-nets.

17. The computer usable program product of claim 11, further comprising:
computer usable code for performing a spreading and legalization operation on the design including the set of virtual filler cells.

18. The computer usable program product of claim 11, wherein the computer usable code is stored in a computer readable storage medium in a data processing system, and wherein the computer usable code is transferred over a network from a remote data processing system.

19. The computer usable program product of claim 11, wherein the computer usable code is stored in a computer readable storage medium in a server data processing system, and wherein the computer usable code is downloaded over a network to a remote data processing system for use in a computer readable storage medium associated with the remote data processing system.

20. A data processing system for whitespace creation and preservation in a design of an integrated circuit (IC), the data processing system comprising:
a storage device including a storage medium, wherein the storage device stores computer usable program code; and
a processor, wherein the processor executes the computer usable program code, and wherein the computer usable program code comprises:
computer usable code for estimating, forming a first estimate, an amount of whitespace that is needed to reduce a congestion value of a congested area of the design to a threshold value;
computer usable code for adding a set of virtual filler cells to the congested area, wherein the adding the set of virtual filler cells does not add actual whitespace cells to the congested area but reduces the congested area by at least the first estimate;
computer usable code for replacing a virtual filler cell in the set of virtual filler cells with a corresponding real filler cell;
computer usable code for determining whether the design has improved; and
computer usable code for creating a final placement solution when the design has not improved.
